(19) United States
(12) Patent Application Publication
(10) Pub. No.: US 2007/0011381 A1
(43) Pub. Date: Jan. 11, 2007

(54) Control method and control circuit for bus system

(75) Inventor: Keitaro Ishida, Tokyo (JP)

Correspondence Address: NIXON PEABODY, LLP, 401 9TH STREET, NW, SUITE 900, WASHINGTON, DC, 20004-2128, US

(73) Assignee: OKI ELECTRIC INDUSTRY CO., LTD., Tokyo (JP)

(21) Appl. No.: 11/474,388

(22) Filed: Jun. 26, 2006

(30) Foreign Application Priority Data
Jul. 7, 2005 (JP) 2005-199295

(51) Int. Cl. G06F 13/36

(52) U.S. Cl. 710/116

(57) ABSTRACT

A control method of the present invention comprises: a step for predetermining a priority level for accessing a slave via a bus with respect to a plurality of bus masters, as a basic priority; a step for determining a reference access frequency with respect to the plurality of bus masters, based on a required transfer rate; a step for counting an actual valid access frequency for each of the plurality of bus masters; a step for measuring a predetermined reference time; a step for determining an actual access priority of the plurality of bus masters based on the reference access frequency of the plurality of bus masters, the valid access frequency within the reference time, and the basic priority; and a step for granting access permission with respect to the plurality of bus masters, according to the actual access priority.

### CROSS REFERENCE TO RELATED APPLICATION

This application claims the priority of Application No. 2005-199295, filed on Jul. 7, 2005 in Japan, the subject matter of which is incorporated herein by reference.

### TECHNICAL FIELD OF THE INVENTION

The present invention relates to an access control method and apparatus of a system in which a plurality of bus masters share a set of buses, and in particular, relates to a bus control method and a controller that controls the right of using a bus that permits access to a specific bus master, with respect to an access request from the bus master.

### BACKGROUND OF THE INVENTION

Conventionally, in this type of bus control circuit, an acquisition priority level of the right of using the bus with respect to each bus master is determined (fixed) in view of hardware, and when requests for using the bus are generated from a plurality of bus masters, a permission signal for using the bus is output to a bus master having a higher priority level. Accordingly, permission for using the bus with respect to the bus master having the higher priority level increases, and permission for using the bus with respect to a bus master having a low priority level is unlikely to be issued.

In a system which requires high-speed data transfer, it is required to assure a certain transfer rate (transfer frequency per unit time) for each bus master, in order to realize the intended operation of the system.

In the invention disclosed in Japanese Unexamined Patent Publication No. Hei 5-89034, there is provided a bus control circuit which can maintain the acquisition frequency (transfer frequency) of the right of using a bus by respective bus masters at a certain ratio. Specifically, when the frequency of being unable to acquire the right of using the bus exceeds a certain value, the right of using the bus is preferentially given to the other bus master. Then a gradient is given to the acquisition frequency of the right of using the bus by the respective bus masters according to a value prestored in a counter initial value circuit, so that the priority of the right of using the bus is raised or lowered according to the acquisition frequency of the right of using the bus by the respective bus masters.

[Patent Document 1] Japanese Unexamined Patent Publication No. Hei 5-89034

However, according to the invention disclosed in Japanese Unexamined Patent Publication No. Hei 5-89034, the priority level is limited to two levels (low and high), and hence it is difficult to apply the invention to a system having priority levels of three levels or more. Moreover, when assurance of a certain transfer rate is required for each bus master, it is not easy to respond to this request.

### OBJECTS OF THE INVENTION

In view of the above situation, it is an object of the present invention to provide a control method and apparatus for a bus system which has an advantage in assuring the transfer rate of the bus masters.

Another object of the present invention is to provide a control method and apparatus that can be easily applied to a system having priority levels of three or more.

Additional objects, advantages and novel features of the present invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

According to a first aspect of the present invention, there is provided an access control method for a bus system in which a plurality of bus masters shares a bus to which at least one slave is connected, comprising:

a step for predetermining a priority level for accessing the slave via the bus with respect to the plurality of bus masters, as a basic priority;

a step for determining a reference access frequency with respect to the plurality of bus masters, based on a required transfer rate;

a step for counting an actual valid access frequency for each of the plurality of bus masters;

a step for measuring a predetermined reference time;

a step for determining an actual access priority of the plurality of bus masters based on the reference access frequency of the plurality of bus masters, the valid access frequency within the reference time, and the basic priority; and

a step for granting access permission with respect to the plurality of bus masters, according to the actual access priority.

According to a second aspect of the present invention, there is provided an access controller for a bus system in which a plurality of bus masters shares a bus to which at least one slave is connected, comprising:

a counter which counts an actual valid access frequency to the slave within a predetermined reference time, for each of the plurality of bus masters;

a priority determination circuit which determines an actual priority level of the plurality of bus masters based on a basic priority relating to access permission to the slave predetermined for each of the plurality of bus masters, a reference access frequency within a predetermined time determined based on a transfer rate required for each of the plurality of bus masters, and the actual valid access frequency output from the counter; and

an arbitration circuit which grants access permission to the plurality of bus masters, according to the actual priority level.

As described above, according to the present invention, the reference access frequency is predetermined based on the requested transfer rate for each of the plurality of bus masters. The actual access priority level is then determined based on the reference access frequency, the valid access frequency within the reference time, and the basic priority as a fixed value. As a result, the transfer rate required by the respective bus masters can be effectively assured.

### BRIEF DESCRIPTION OF THE DRAWINGS

FIG. 1 is a block diagram showing a schematic configuration of a bus system, to which the present invention is applied;

FIG. 2 is a block diagram showing the configuration of a control circuit in the bus system according to a first embodiment of the present invention;

FIG. 3 is a block diagram showing the configuration of a priority determination circuit, being the main part of the control circuit according to the first embodiment;

FIG. 4 is a table showing an action in the first embodiment, and a logical pattern of a priority table generation circuit;

FIG. 5 is a timing chart showing an operation in the first embodiment;

FIG. 6 is a block diagram showing the configuration of a control circuit in a bus system according to a second embodiment of the present invention;

FIG. 7 is a block diagram showing the configuration of a priority determination circuit, being the main part of the control circuit according to the second embodiment; and

FIG. 8 is a table showing an action in the second embodiment, and a logical pattern of a priority table generation circuit.

### DETAILED DISCLOSURE OF THE INVENTION

In the following detailed description of the preferred embodiments, reference is made to the accompanying drawings which form a part thereof, and in which is shown by way of illustration specific preferred embodiments in which the invention may be practiced. These preferred embodiments are described in sufficient detail to enable those skilled in the art to practice the invention, and it is to be understood that other preferred embodiments may be utilized and that logical, mechanical and electrical changes may be made without departing from the spirit and scope of the present invention. The following detailed description is, therefore, not to be taken in a limiting sense, and the scope of the present invention is defined only by the appended claims.

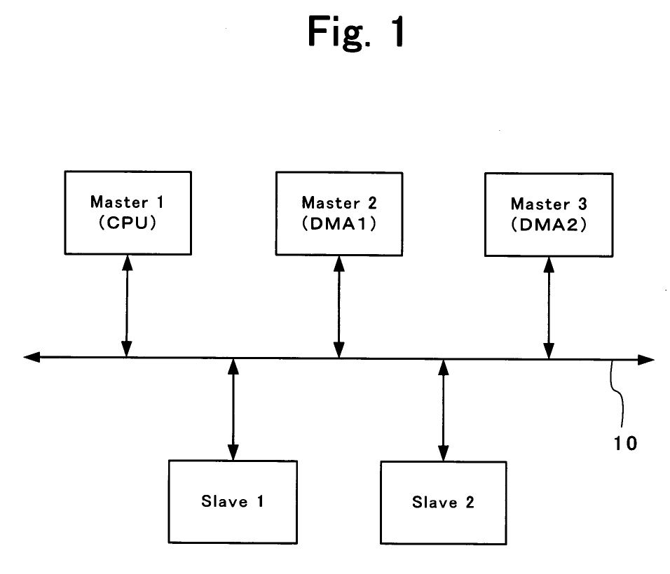

A best mode for carrying out the invention will be explained in detail by way of examples. FIG. 1 is a block diagram showing a schematic configuration of a bus system, to which the present invention is applied. The present invention is applied to a bus system in which a plurality of bus masters (masters 1, 2, and 3) shares a bus 10 to which at least one slave (slaves 1, and 2) is connected. The system (LSI) to which the present invention can be applied includes an image processing LSI, a communication LSI, a voice LSI, and the like. The bus master includes, for example, a CPU and a DMA. On the other hand, the slave includes, for example, a memory (memory controller), a USB controller, and an A/D controller.

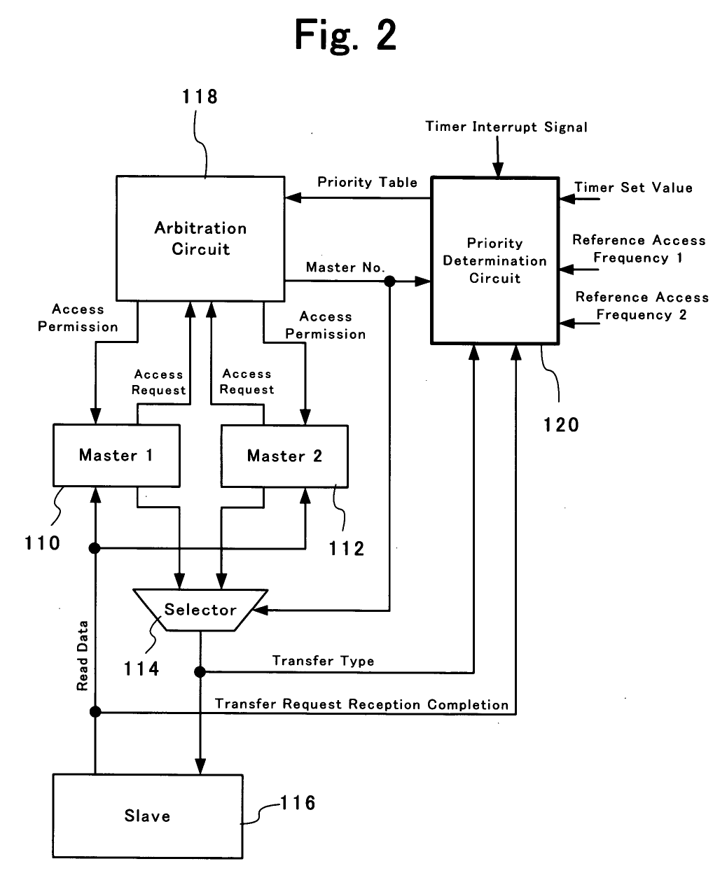

FIG. 2 is a block diagram showing the configuration of a controller in the bus system according to a first embodiment of the present invention. The controller in this embodiment controls access (permission to use the bus) to a slave 116 by the master 1 (110) and the master 2 (112) connected to the bus. In the embodiment, for convenience of explanation, the system includes two masters and one slave, but the number of masters and slaves is not limited thereto. The controller in the embodiment includes an address selector 114 which selects an address from the master 1 (110) and the master 2 (112), an arbitration circuit 118 which permits access in response to a request from the master 1 (110) or 2 (112), and a priority determination circuit 120 for determining access priority of the masters 1 (110) and 2 (112).

The masters 1 (110) and 2 (112) output an access request signal to the arbitration circuit 118. Upon input of an access permission signal from the arbitration circuit 118, the masters 1 (110) and 2 (112) output an address, transfer type, write data and the like of the slave 116 to be accessed. The signal from the masters 1 (110) and 2 (112) is supplied to an input terminal of the address selector 114. An output terminal of the address selector 114 is connected to an input terminal of the slave 116. The arbitration circuit 118 selects a master, whose access is permitted, according to a priority table supplied from the priority determination circuit 120. The arbitration circuit 118 outputs access permission to the master, and also transmits a master number (1 or 2) for specifying the relevant master, to the address selector 114.

The masters 1 (110) and 2 (112) output a signal indicating the transfer type as well as the address signal, to the address selector 114. The transfer type includes a signal indicating whether the transfer (access) is valid or invalid, and whether the address is continuous. For example, “NSQ” indicates a valid address and that the address is not continuous, and “SEQ” indicates a valid address and that the address is continuous.

The address selector 114 selects the address signal of the master specified (access permitted) by the master number from the arbitration circuit 118 and outputs the address signal to the slave 116. The address selector 114 also outputs the transfer type of the master, whose access is permitted, to the priority determination circuit 120. Upon input of the address from the address selector 114, the slave 116 outputs a signal indicating completion of receipt of a transfer request, to the priority determination circuit 120. The slave 116 outputs data corresponding to the input address, as required, to the corresponding master (110 or 112).

A timer interrupt signal, a timer set value, a reference number of access 1 of the master 1 (110), and a reference number of access 2 of the master 2 (112) are input to the priority determination circuit 120 from outside. The master number, the transfer type, and a transfer request reception completion signal are input to the priority determination circuit 120, in addition to the signal input from outside. Then the priority table is generated in the priority determination circuit 120 based on these input signals, and output to the arbitration circuit 118.

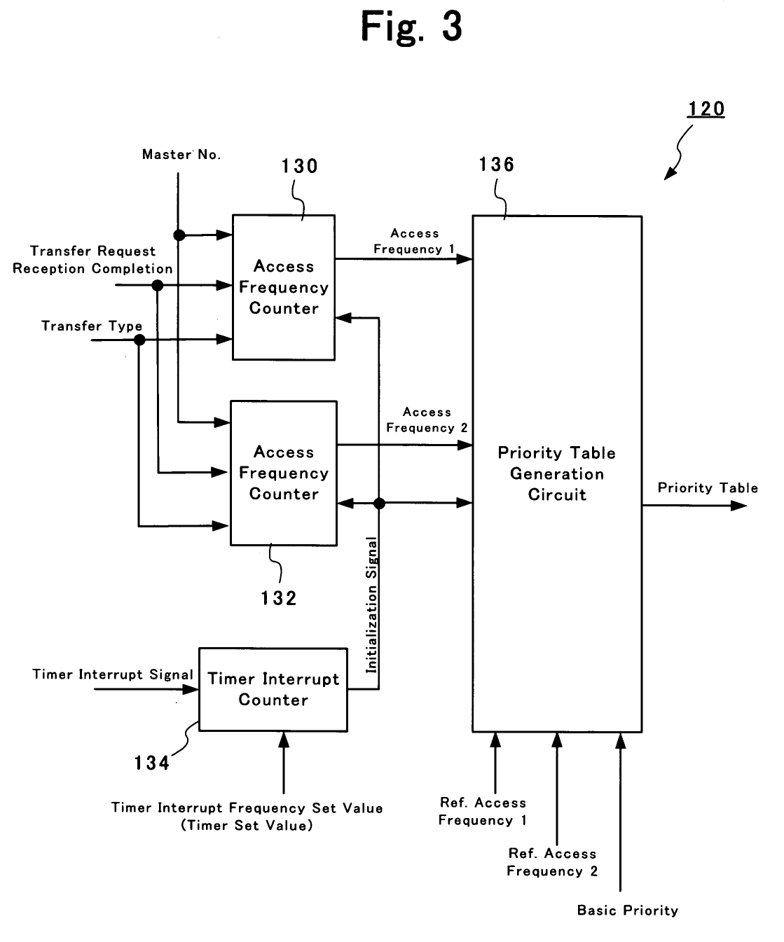

FIG. 3 is a block diagram showing the configuration of the priority determination circuit 120, being the main part of the control circuit according to the first embodiment. The priority determination circuit 120 includes an access frequency counter 130 for counting the number of valid accesses of the master 1 (110), an access frequency counter 132 for counting the number of valid accesses of the master 2 (112), a timer interrupt counter 134 for measuring a predetermined reference time, and a priority table generation circuit 136 which generates the priority table.

The master number, the transfer type, and the transfer request reception completion signal are input to the respective access frequency counters 130-and 132. The access frequency counters 130 and 132 count the actual valid access frequencies of the masters 1 (110) and 2 (112) based on these input signals, and output the access frequencies to the priority table generation circuit 136, as the access frequencies 1 and 2. When the transfer type signal and the transfer request reception completion signal are valid, and the master number indicates number 1, the access frequency counter 130 counts up the access number of the master 1 (110) by one. When the transfer type signal and the transfer request reception completion signal are valid, and the master number indicates number 2, the access frequency counter 132 counts up the access number of the master 2 (112) by one. When the transfer type continues, for example, NSQ, SEQ, SEQ, the valid access frequency becomes “3”.

The timer interrupt counter 134 functions as a timer for measuring the reference time. The timer interrupt counter 134 counts the timer interrupt signal in a certain cycle supplied from the outside, until the count reaches a timer interrupt frequency set value input from the outside (by reference time). The timer interrupt counter 134 initializes its count value to zero at the time of finishing the count, and outputs an initialization signal to the access frequency counters 130 and 132, and the priority table generation circuit 136. That is, the access frequency counters 130 and 132, and the priority table generation circuit 136 are initialized for each reference time. In the case of the image processing LSI, the reference time can be set to, for example, 1 to 10 microseconds.

The reference access frequencies 1 and 2, and a reference priority level (fixed value) relating to the access permission of the masters 1 (110) and 2 (112) are set and input to the priority table generation circuit 136 from the outside beforehand. The reference access frequencies 1 and 2 are the number of accesses set with respect to the masters 1 (110) and 2 (112), and are determined based on a transfer rate requested (assured) for each master, and the reference time. That is, a numerical value linked directly with the requested transfer rate can be set as the reference access frequency. The actual reference access frequency can be (transfer rate)×(reference time) or more, or less. When the master is the DMA, the transfer rate can be, for example, 2.6 M times per second.

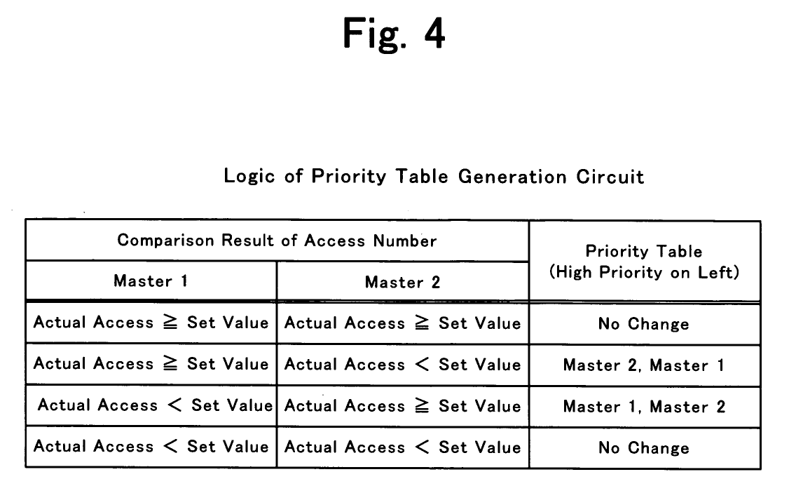

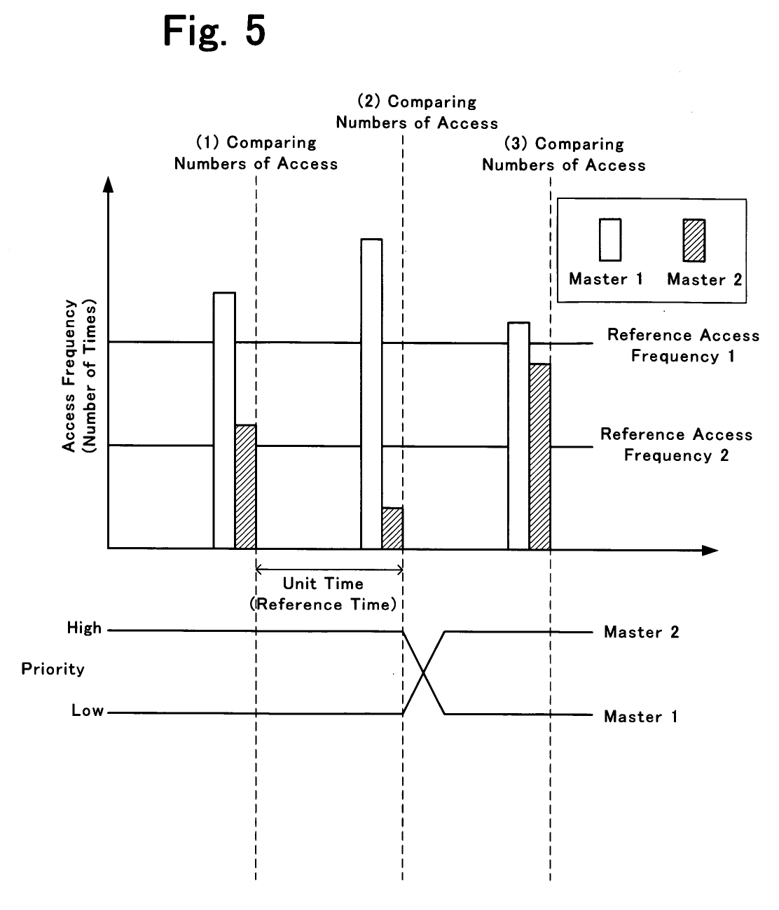

The priority table generation circuit 136 generates the priority table based on all the input data (reference access frequencies 1 and 2, access frequencies 1 and 2, and reference priority), and outputs the priority table to the arbitration circuit 118. FIG. 4 is a table showing an action in the first embodiment, and a logical pattern of the priority table generation circuit 136. In the table, “access number” stands for the access frequency, and “set value” stands for the reference access frequency. FIG. 5 is a timing chart showing the operation in the first embodiment.

In the reference priority set by the priority table determination circuit 120, it is assumed that the master 1 (110) has a higher priority than the master 2 (112). A comparison between the reference access frequency and the access frequency in the priority table generation circuit 136 is executed at a point in time when the reference time (unit time) measured by the timer interrupt counter 134 has elapsed. That is, the comparison is executed at the timing when the initialization signal is asserted from the timer interrupt counter 134. As a result of the comparison (1) between the reference access frequency and the access frequency, since the access frequencies of the masters 1 (110) and 2 (112) exceed the reference access frequencies 1 and 2, respectively, the priority table is not changed.

A comparison between the reference access frequency and the access frequency (2) is executed after the reference time has elapsed since the access number comparison (1). As a result of the comparison (2), the access frequency of the master 1 (110) exceeds the reference access frequency 1, but the access frequency of the master 2 (112) does not reach the reference access frequency 2. The priority table generation circuit 136 dynamically changes (updates) the priority table according to the logic in the table shown in FIG. 4, so that the priority of the master 2 (112) becomes higher than the master 1 (110). As a result, the access permission is preferentially given to the master 2 (112) prior to the master 1 (110), and the access number by the master 2 (112) increases.

A comparison between the reference access frequency and the access frequency (3) is executed again after the reference time has elapsed since the access number comparison (2). As a result of the comparison (3), since the access frequencies of the masters 1 (110) and 2 (112) exceed the reference access frequencies 1 and 2, respectively, the priority table is not changed.

As described above, in the first embodiment, when the priority table generation circuit 136 monitors the access frequency of the respective masters, and the access number of the master per unit time is lower than a value requested as the transfer rate, the priority of the master is raised. Thus, the priority of the respective masters can be dynamically adjusted, and the actual valid access number of the respective masters can be brought close to the requested transfer rate. In the first embodiment, not only the priority is simply raised or lowered, but also the priority table is dynamically updated, and according to circumstances, the priority may not be changed.

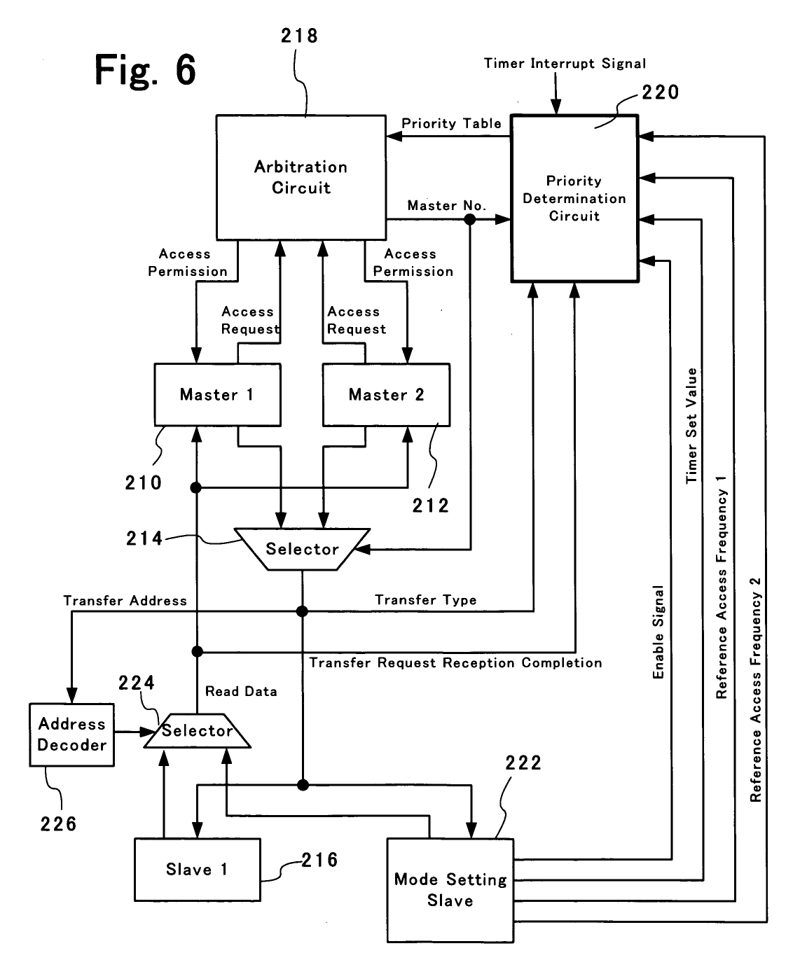

FIG. 6 is a block diagram showing the configuration of a control circuit in a bus system according to a second embodiment of the present invention. In the second embodiment, a mode setting slave 222, a response selector 224, and an address decoder 226 are added to the configuration of the first embodiment, so that the reference access frequencies 1 and 2, and the timer set value are generated within the system. This will be described below in detail.

The controller in this embodiment controls access (permission to use the bus) to slaves 216 and 222 by the master 1 (210) and the master 2 (212) connected to the bus. In the embodiment, for convenience of explanation, the system includes two masters and two slaves, but the number of masters and slaves is not limited thereto. The controller in the second embodiment includes an address selector 214 which selects an address from the master 1 (210) and the master 2 (212), an arbitration circuit 218 which permits access in response to a request from the master 1 (210) or 2 (212), and a priority determination circuit 220 for determining access priority of the masters 1 (210) and 2 (212). The controller in the second embodiment further includes the response selector 224 which selects data from the slave to the master, and the address decoder 226 which decodes a transfer address and supplies the address to the response selector 224.

The masters 1 (210) and 2 (212) output an access request signal to the arbitration circuit 218. Upon input of an access permission signal from the arbitration circuit 218, the masters 1 (210) and 2 (212) output an address, transfer type, write data and the like of the slave to be accessed. The signal output from the masters 1 (210) and 2 (212) is supplied to an input terminal of the address selector 214. An output terminal of the address selector 214 is connected to the address decoder 226 and the priority determination circuit 220, as well as to the input terminals of the slaves 216 and 222. The arbitration circuit 218 selects a master, whose access is permitted, according to a priority table supplied from the priority determination circuit 220. The arbitration circuit 218 outputs access permission to the master, and also transmits a master number (1 or 2) for specifying the relevant master, to the address selector 214 and the priority determination circuit 220.

The masters 1 (210) and 2 (212) output a signal indicating the transfer type as well as the address signal, to the address selector 214. The transfer type includes a signal indicating whether the transfer (access) is valid or invalid, and whether the address is continuous. For example, “NSQ” indicates a valid address and that the address is not continuous, and “SEQ” indicates a valid address and that the address is continuous.

The address selector 214 selects the address signal of the master specified (access permitted) by the master number from the arbitration circuit 218 and outputs the address signal to the slaves 216 and 222. The address selector 214 also outputs the transfer type of the master, whose access is permitted, to the priority determination circuit 220. Upon input of the address from the address selector 214, the slaves 216 and 222 output a signal indicating completion of receipt of a transfer request, to the priority determination circuit 120 via the response selector 224. The slave 216 outputs data corresponding to the input address, as required, to the corresponding master (210 or 212) via the response selector 224.

A timer interrupt signal is input to the priority determination circuit 220 from outside. The mode setting slave 222 supplies the timer set value, the reference access frequency 1 of the master 1 (210), the reference number 2 of the master 2 (212), and an enable signal, to the priority determination circuit 220. The master number, the transfer type, and a transfer request reception completion signal are input to the priority determination circuit 220, in addition to the above signals. Then the priority table is generated in the priority determination circuit 220 based on these input signals, and output to the arbitration circuit 218. The basic configuration and the operation of the priority determination circuit 220 are the same as those of the priority determination circuit 120 shown in FIG. 3. The only difference from the first embodiment is that the enable signal is input from the mode setting slave 222 to the priority determination circuit 220 in the second embodiment.

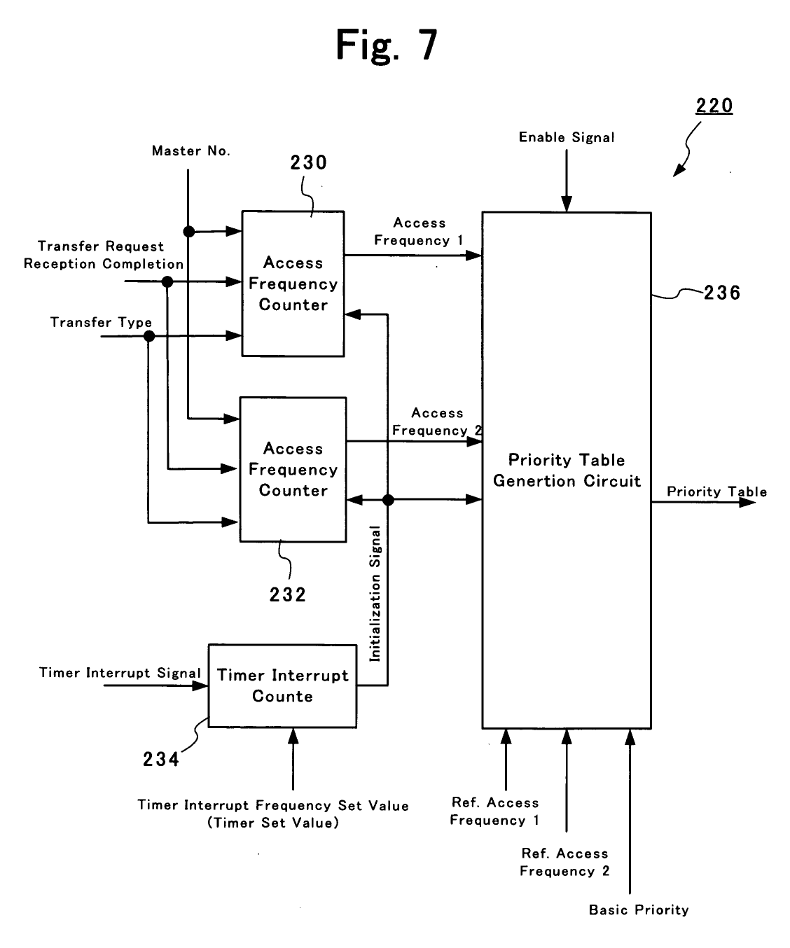

FIG. 7 is a block diagram showing the configuration of the priority determination circuit 220, being the main part of the control circuit according to the second embodiment. The priority determination circuit 220 includes an access frequency counter 230 for counting the number of valid accesses of the master 1 (210), an access frequency counter 232 for counting the number of valid accesses of the master 2 (212), a timer interrupt counter 234 for measuring a predetermined reference time, and a priority table generation circuit 236 which generates the priority table.

The master number, the transfer type, and the transfer request reception completion signal are input to the respective access frequency counters 230 and 232. The access frequency counters 230 and 232 count the actual access frequencies of the masters 1 (210) and 2 (212) based on these input signals, and output the access frequencies to the priority table generation circuit 236, as the access frequencies 1 and 2. When the transfer type signal and the transfer request reception completion signal are valid, and the master number indicates number 1, the access frequency counter 230 counts up the access frequency of the master 1 (210) by one. When the transfer type signal and the transfer request reception completion signal are valid, and the master number indicates number 2, the access frequency counter 232 counts up the access number of the master 2 (212) by one. When the transfer type continues, for example, NSQ, SEQ, SEQ, the valid access frequency becomes “3”.

The address decoder 226 decodes the address selected by the address selector 214 and generates a number of the slave to be accessed. The response selector 224 returns the response signal of the selected slave to the masters 1 (210) and 2 (212) according to the slave number indicated by the address decoder 226. The mode setting slave 222 updates a register built therein by write access from the masters 1 (210) and 2 (212), and holds the value. The value of the register is output as the mode set value, to the priority determination circuit 220. Here the mode set value indicates the enable signal, the timer set value, and the reference access frequencies 1 and 2.

The timer interrupt counter 234 functions as a timer for measuring the reference time. The timer interrupt counter 234 counts the timer interrupt signal in a certain cycle supplied from the outside, until the count reaches a timer interrupt frequency set value (timer set value) input from the mode setting slave 222. The timer interrupt counter 234 initializes its count value to zero at the time of finishing the count, and outputs an initialization signal to the access frequency counters 230 and 232, and the priority table generation circuit 236. That is, the access frequency counters 230 and 232, and the priority table generation circuit 236 are initialized for each reference time. In the case of the image processing LSI, the reference time can be set to, for example, 1 to 10 microseconds.

The reference access frequencies 1 and 2 input from the mode setting slave 222, as well as the basic priority (fixed value) relating to the access permission of the masters 1 (210) and 2 (212) are set in the priority table generation circuit 236. The reference access frequencies 1 and 2 are the number of accesses set with respect to the masters 1 (210) and 2 (212), and are determined based on a transfer rate requested (assured) for each master, and the reference time. That is, a numerical value linked directly with the requested transfer rate can be set as the reference access frequency. The actual reference access frequency, which could be described “number of times of reference access”, can be calculated by an equation: (transfer rate) x (reference period of time) or more, or less. When the master is the DMA, the transfer rate can be, for example, 2.6 M times per second.

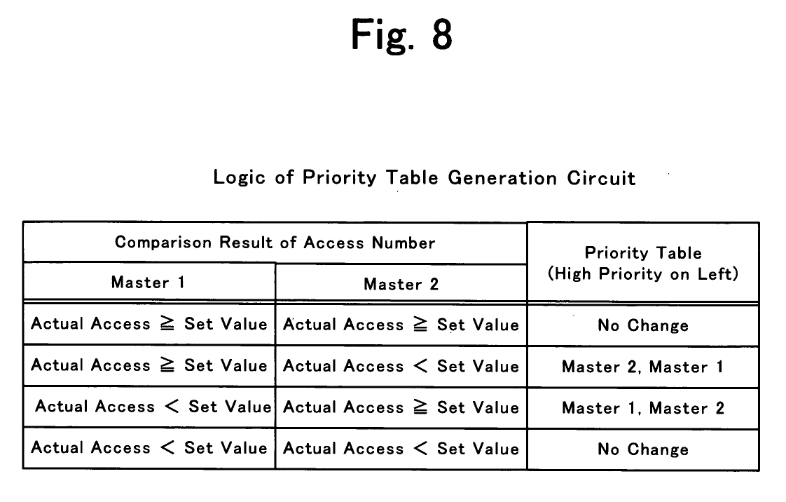

The priority table generation circuit 236 generates the priority table based on the input data (reference access frequencies 1 and 2, access frequencies 1 and 2, and basic priority), and outputs the priority table to the arbitration circuit 218. FIG. 8 is a table showing an action in the second embodiment, and a logical pattern of the priority table generation circuit 236. In the table, “access number” stands for the access frequency, and “set value” stands for the reference access frequency. Since the specific generation operation of the priority table is the same as in the first embodiment, explanation thereof is omitted. When the enable signal from the mode setting slave 222 is deasserted, the priority table indicates the initial value of the priority table, and change and update of the priority table are not performed.

When the reference access frequencies 1 and 2, and the timer set value are to be changed during the operation of the system, the setting can be easily changed by accessing the mode setting slave 222. As described above, operation/suspension of the priority determination circuit 220 can be selected by changing the enable signal. This control can be performed by a program executed by the CPU as the master.

In the second embodiment, there are the following effects in addition to the effects due to the first embodiment. In other words, in the second embodiment, since the priority table generation circuit 236 can be operated or suspended, the flexibility in adjustment of the priority of respective masters is improved according to the situation of the system. Moreover, since the reference access frequency of respective masters can be changed during the operation of the system, then even when the transfer rate required for the respective masters is changed, this can be handled flexibly.

Embodiments of the present invention have been explained above, but the present invention is not limited to these embodiments, and the design can be appropriately changed within the scope of the technical concepts indicated in the claims. The words “frequency” may be described in other words of “the number of times” in this specification.

What is claimed is:

1. An access control method for a bus system in which a plurality of bus masters shares a bus to which at least one slave is connected, comprising:
a step for predetermining a priority level for accessing said slave via said bus with respect to said plurality of bus masters, as a basic priority;
a step for determining a reference access frequency with respect to said plurality of bus masters, based on a required transfer rate;
a step for counting an actual valid access frequency for each of said plurality of bus masters;
a step for measuring a predetermined reference time;
a step for determining an actual access priority of said plurality of bus masters based on said reference access frequency of said plurality of bus masters, said valid access frequency within said reference time, and said basic priority; and
a step for granting access permission with respect to said plurality of bus masters, according to said actual access priority.

2. An access control method for a bus system according to claim 1, wherein
said reference access frequency and said valid access frequency are compared for each of said plurality of bus masters, and
said actual access priority is determined based on the comparison result and said basic priority.

3. An access control method for a bus system according to claim 1, wherein
said reference access frequency is set from the outside of the system.

4. An access control method for a bus system according to claim 1, wherein
said reference access frequency can be set and changed within the system.

5. An access control method for a bus system according to claim 4, wherein
said reference access frequency can be set and changed by one slave connected to said bus.

6. An access control method for a bus system according to claim 1, wherein
said actual access priority can be set to valid or invalid.

7. An access control method for a bus system according to claim 6, wherein
the setting of said actual access priority to valid or invalid can be executed by one slave connected to said bus.

8. An access control method for a bus system according to claim 1, wherein
said reference time is set and changed from the outside of the system.

9. An access control method for a bus system according to claim 1, wherein
said reference time can be set and changed within the system.

10. An access control method for a bus system according to claim 9, wherein
setting and change of said reference time can be executed by one slave connected to said bus.

11. An access controller for a bus system in which a plurality of bus masters shares a bus to which at least one slave is connected, comprising:
a counter which counts an actual valid access frequency to said slave within a predetermined reference time, for each of said plurality of bus masters;
a priority determination circuit which determines an actual priority level of said plurality of bus masters based on a basic priority relating to access permission to said slave predetermined for each of said plurality of bus masters, a reference access frequency within a predetermined time determined based on a transfer rate required for each of said plurality of bus masters, and the actual valid access frequency output from said counter; and
an arbitration circuit which grants access permission to said plurality of bus masters, according to said actual priority level.

12. An access controller for a bus system according to claim 11, wherein
said priority determination circuit compares said reference access frequency and said valid access frequency for each of said plurality of bus masters, and determines said actual access priority based on the comparison result and said basic priority.

13. An access controller for a bus system according to claim 11, wherein
said reference access frequency is set from the outside of the system.

14. An access controller for a bus system according to claim 11, further comprising:
a slave connected to said bus, which can set and change said reference access frequency.

15. An access controller for a bus system according to claim 11, wherein
said priority determination circuit has a configuration capable of changing over said actual access priority to valid or invalid.

16. An access controller for a bus system according to claim 15, further comprising:
a slave connected to said bus, which can change over said actual access priority in said priority determination circuit to valid or invalid.

17. An access controller for a bus system according to claim 11, wherein
said reference time is set and changed from the outside of the system.

18. An access controller for a bus system according to claim 11, further comprising:
a slave connected to said bus, which can set and change said reference time.
